(19) United States
(12) Patent Application Publication
(10) Pub. No.: US 2002/0029261 A1
(43) Pub. Date: Mar. 7, 2002

(54) Information supply system and control method thereof

(76) Inventor: Junji Shibata, Tokyo (JP)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/946,590

(22) Filed: Sep. 6, 2001

(30) Foreign Application Priority Data
Sep. 7, 2000 (JP) 2000-272143

(51) Int. Cl. G06F 15/16

(52) U.S. Cl. 709/219; 709/218

(57) ABSTRACT

To provide an information supply system that supplies desired information to service subscribers, capable of automatically selecting and supplying information required by the user from whole information. Local servers 4 to 6 are provided with user DB 8 to 10 that store reception settings set by individual service subscribers. When service subscriber terminal moves to a service area of an access point connected, a local server establishes a channel with the service subscriber terminal, and references the corresponding reception setting from a user DB and only presents the message that matches the reception setting from message data stored in the local server to the service subscriber terminal.

### FIELD OF THE INVENTION

The present invention relates to an information supply system and its control method, and more particularly, to an information supply system and its control method capable of selecting a transmission destination of information or information to be acquired.

### BACKGROUND OF THE INVENTION

With progress of communication technologies in recent years, information is now obtainable worldwide without any time differences, and with the spread of the Internet it is now becoming possible to easily access a huge amount of information.

Generally, to find desired information from homepages on the Internet, the specific addresses of homepages where the desired information is provided should be found magazines, etc., and then access the homepages by using the found addresses, or find homepages where the desired information may be provided by searching a search site which is a homepage dedicated to homepage search, using keyword(s), or track hierarchical links provided by the search site.

However, in case of a keyword search, the search result is influenced greatly by how a keyword(s) is selected. Moreover, few keyword results in huge number of hits include many unrelated homepages. Therefore, it is necessary add another keyword(s) to reduce undesired (unrelated) homepages, or access possible homepages one by one relying on short summary of pages and check their contents.

Moreover, at the time of searching information by tracing links for each category provided by the search site, though the possibility that totally irrelevant home pages will be included in links is small, homepages not linked by the search site are not displayed. Moreover, the desired category may not exist, either.

In addition, information supplied by a homepage searched in this way also includes obsolete information without any information values. Moreover, such a page may not actually exist even if the homepage is accessed.

Furthermore, since the situation of a searcher, that is, his/her current address, sex, age, etc. have nothing to do with search results, even simply searching information on the neighborhood of the searcher's address also requires the searcher to specify the location by entering a keyword, etc.

On the other hand, from the standpoint of an information provider, supplying information to those who do not need the information is meaningless. For example, in case of providing information on a bargain sale of children's clothing, supplying the information to childless people is unlikely to bring expected advertisement effects.

### SUMMARY OF THE INVENTION

The present invention has been implemented taking into account the points described above and it is an object of the present invention to provide an information supply system and its control method that supplies desired information to users, capable of automatically selecting and supplying information requested by the users from the whole information.

Another object of the present invention is to provide an information supply system and its control method that supplies desired information to users, allowing the sender of information to select the destination of the information transmitted using user-specific information.

That is, according to an aspect of the present invention, there is provided an information system that supplies pre-stored information to service a subscriber terminal that exist in a service area, comprising: at least one local server means having a service area of a predetermined range and a central server means connecting local server means; an information supply system comprising information database means for storing information associated with transmission destination specification conditions, subscriber database means for storing information reception conditions set for each service subscriber terminal, information selecting means for comparing information reception conditions corresponding to service subscriber terminal that exist in the service area of the local server means with transmission destination specification conditions using the information database means and the subscriber database means and selecting only information having transmission destination specification conditions that meet information reception conditions, and information supplying means for presenting only information selected by the information selecting means to the service subscriber terminal that exist in the service area.

According to an aspect of the present invention, there is provided a method of controlling an information supply system that supplies pre-stored information to service subscriber terminals that exist in a service area, comprising at least one local server means having a service area of a predetermined range, a central server means connecting local server means, and information database means for storing information associated with transmission destination specification conditions and subscriber database means for storing information reception conditions set for each service subscriber terminal; a method of controlling an information supply system comprising an information selecting step of comparing information reception conditions corresponding to service subscriber terminal that exist in the service area of the local server means with transmission destination specification conditions using the information database means and the subscriber database means and selecting only information having transmission destination specification conditions that meet information reception conditions, and an information supplying step of presenting only information selected by the information selecting means to the service subscriber terminal that exist in the service area.

### BRIEF DESCRIPTION OF THE DRAWINGS

FIG. 1 illustrates an overall configuration example of an information supply system according to an embodiment of the present invention;

FIG. 2 is a block diagram showing a configuration example of a local server in FIG. 1;

FIG. 3 is a block diagram showing a configuration example of a central processing server 1 in FIG. 1;

FIG. 4 is a flow chart showing channel control processing of access points in FIG. 1;

FIG. 5 is a flow chart to explain a flow of entire information supply processing of the local server;

FIGS. 6A to 6G illustrates a screen display example of mobile radio communication terminal 7 at the time of new registration;

FIGS. 7A to 7G illustrate group processing menus displayed on a terminal of a registered user and a screen display example related to processing performed from this menu;

FIGS. 8A to 8G illustrate screen display examples when a message is created on a mobile radio communication terminal 7;

FIG. 9 is a flow chart to explain processing of the local server when a message is created;

FIG. 10 illustrates a data format example of a message used in this system;

FIGS. 11A to 11C illustrate screen display examples during message browsing in the mobile radio communication terminal 7;

FIG. 12 is a flow chart to explain processing of the local server during message browsing;

FIGS. 13A to 13D illustrate screen display examples when a message is changed/deleted in the mobile radio communication terminal 7;

FIG. 14 is a flow chart to explain processing of the local server when a message is changed/deleted;

FIG. 15 is a flow chart to explain message transfer processing in a central processing server 1;

FIGS. 16A to 16D illustrate screen display examples in the mobile radio communication terminal 7 when broadcast data is set;

FIGS. 17A to 17C illustrate screen examples displayed in the mobile radio communication terminal 7 in a service area in which broadcast data exists; and

FIG. 18 is a flow chart to explain broadcast processing in the local server.

### DETAILED DESCRIPTION OF THE PREFERRED EMBODIMENTS

With reference now to the attached drawings, preferred embodiments of the present invention will be explained in detail below.

(Overall configuration)

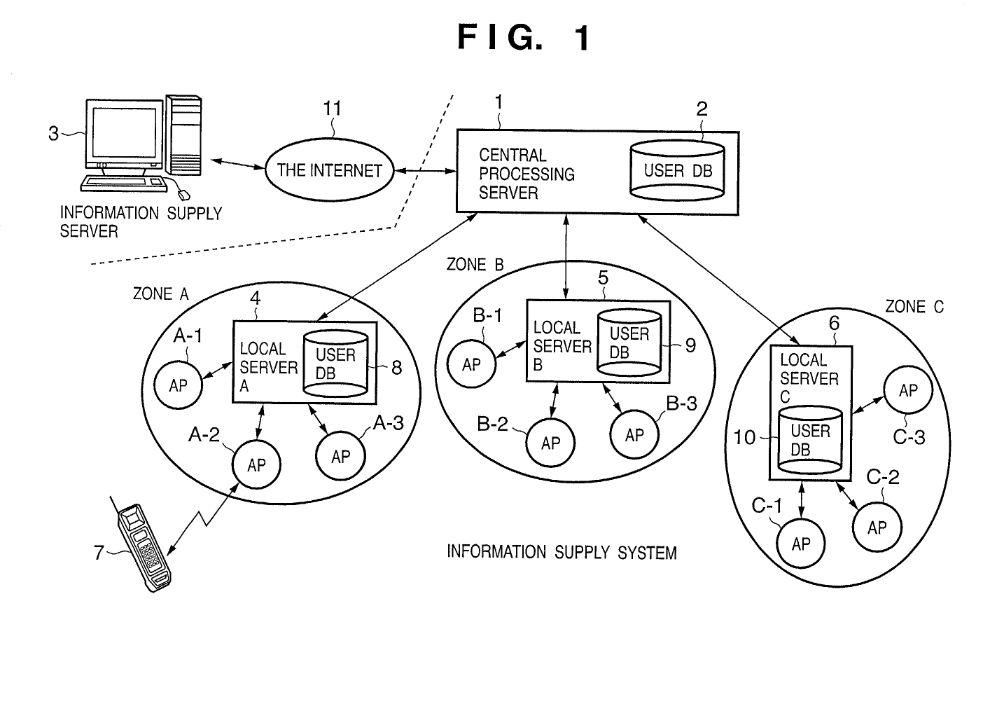

FIG. 1 illustrates an overall configuration example of an information supply system according to an embodiment of the present invention. In the drawing, the information supply system includes three local servers 4 to 6, access points (APs) A-1 to A-3, B-1 to B-3, C-1 to C-3 connected to these local servers respectively and a central processing server 1 to which all local servers 4 to 6 are connected. The central processing server 1 has a function of communication interface between this system and the Internet 11 and supports communications between an information supply server 3 connected to the Internet 11 and the local servers 4 to 6. The central processing server 1 also performs processing such as transferring messages received from the local servers 4 to 6.

The local servers 4 to 6 are located geographically far from each other having as their service areas zone A to zone C, respectively. Each AP is a radio base station having a service area of a relatively small range, for example a range of less than 100 m. Therefore, the zone covered by each local server is a relatively small range and more specifically, local servers are located at each station, each floor of buildings or each shopping district, etc.

A mobile radio communication terminal 7 is provided with a function of establishing a radio connection with each AP and when the mobile radio communication terminal 7 enters the support range of each AP, a radio communication channel is established between the AP and mobile radio communication terminal 7.

Furthermore, the central processing server 1 and local servers 4 to 6 each have user DB2, 8 to 10 having information on registered users of this information supply system. Each user DB has the same contents and synchronization processing is periodically carried out on all user DBs. Of course, it is also possible to provide one user DB accessible to the local servers 4 to 6 and the central processing server with and control the user DB in a centralized manner.

FIG. 1 shows the case where three local servers are connected to the central processing server 1 and three APs are connected to each local server, but these numbers can be set arbitrarily and the number of APs connected to local servers can be mutually different and set arbitrarily. Likewise, the number and locations of mobile radio communication terminals 7 can be set arbitrarily. (Configuration of a local server)

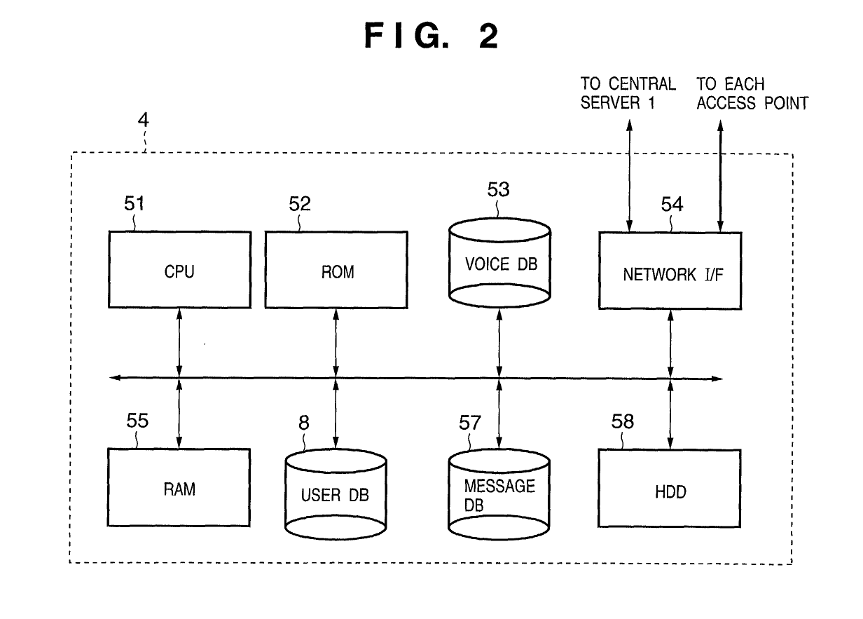

FIG. 2 is a block diagram showing a configuration example of the local server 4. The local server 4 includes a CPU 51 that controls the entire system, a ROM 52 that stores programs executed by the CPU 51 and various data, a voice DB 53 that stores or accumulates voice data such as voice guidance and recorded voice, a network I/F 54, which is an interface for data communications between the central processing server 1 and each AP, a RAM 55 used as a work area, etc. of the CPU 51, a user DB 8 that stores information on registered subscribers of this system, a message DB 57 that stores messages registered in an electronic bulletin board service (BBS) serviced by the local server 4 and an HDD 58 that stores programs executed by the CPU 51 and application programs, etc. to be uploaded to mobile radio communication terminals as required.

These components are connected to each other via a bus (includes a data bus, an address bus and a control bus) of the CPU 51. The voice DB 53, user DB 8 and message DB 57 are described separately in the figure, but these databases can also be configured to occupy some areas of the HDD 58.

Furthermore, FIG. 2 describes only the local server 4, but the local servers 5 and 6 also have the same configuration and individual explanations of these local servers are omitted here. These local servers 4 to 6 can be implemented by a general-purpose computer apparatus having a network interface.

Configuration of a Central Processing Server 1

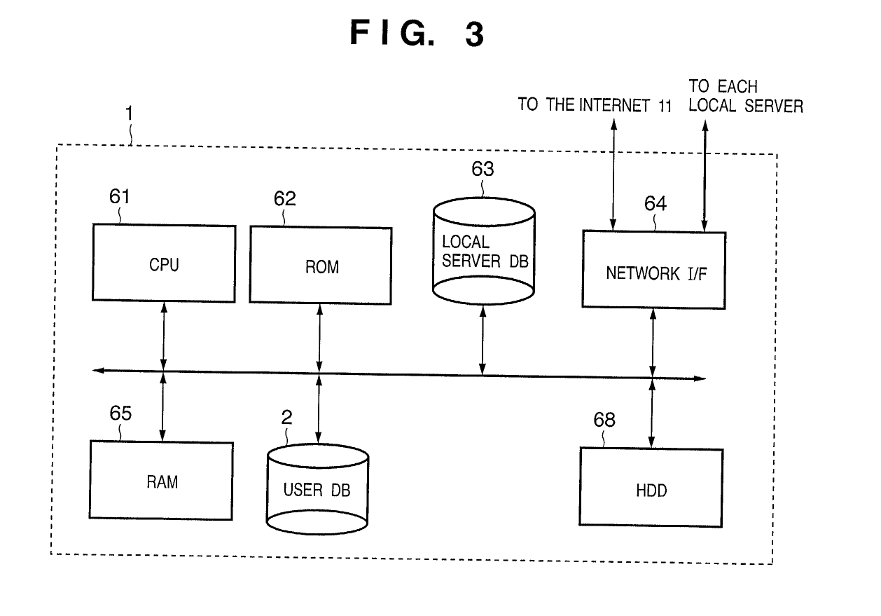

FIG. 3 is a block diagram showing a configuration example of the central processing server 1. The central processing server 1 includes a CPU 61 that controls the entire system, a ROM 62 that stores programs executed by the CPU 61 and various data, a local server DB 63 that stores the correspondence between locations specified as the transmission destination of messages, etc. and the local servers 4 to 6, a network I/F 64, which is an interface for data communications between the Internet 11 and the local servers 4 to 6, a RAM 65 used as a work area, etc. of the CPU 61, a user DB 2 that stores information on registered subscribers of this system, and an HDD 68 that stores programs executed by the CPU 61.

These components are connected to each other via a bus (data bus, address bus and control bus) of the CPU 61. The local server DB 63 and user DB 2 are described separately in the figure, but these databases can be configured to occupy some areas of the HDD 68. This central processing server 1 can be implemented by a general-purpose computer apparatus having a network interface.

Explanation of Operation

Hereinafter, how this system supplies information to a subscriber having a mobile radio communication terminal 7 will be explained step by step.

As described above, a service area (zone) assigned to each local server in this embodiment is relatively small.

Therefore, it is possible to selectively supply information to the mobile radio communication terminal 7 that exists in the zone. In this embodiment, information is supplied to the mobile radio communication terminal 7 based on an electronic bulletin board service (so-called BBS) and this is combined with a push service that automatically distributes information and a broadcast service that supplies information continuously.

And, the information supply system according to the present invention is characterized in that only appropriate information is selectively supplied from the information stored in the local server by combining personal information such as the position of a registered subscriber who receives information, previously registered hobby, age and sex, etc.

For example, the local server A (4) having zone A as its service area is provided with information on zone A or its surroundings or BBS that stores only messages specified to be distributed to the mobile radio communication terminal 7 in zone A. Then, the local server A selects and supplies only appropriate information from the information stored in the BBS consulting the user DB 8 on the previously registered personal information about the subscriber of the mobile radio communication terminal 7 that exists in zone A.

In this embodiment, using information supply service provided by this system requires the user to be registered beforehand. The user is registered by the user's mobile radio communication terminal 7 communicating with the local server via one of APs included in this system. First, it is necessary to establish a channel for a communication between the mobile radio communication terminal 7 and the local server.

Connection Control Processing

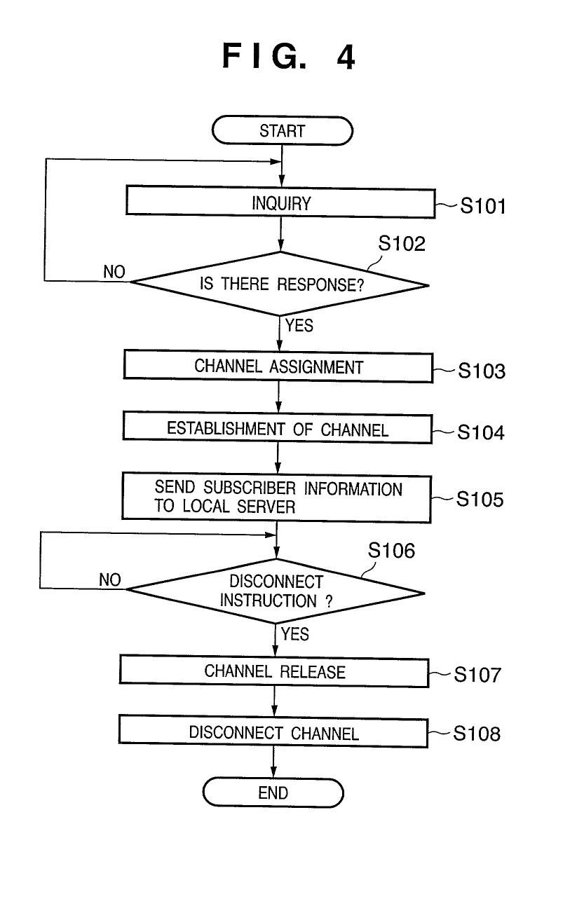

FIG. 4 is a flow chart to explain channel control processing carried out by each AP. Each access point sends an inquiry signal once every predetermined time (e.g., every one second) via an antenna (step S101). When the mobile radio communication terminal 7 receives the inquiry signal sent by the access point, it responds to the inquiry. When the AP detects the response instep S102, the AP assigns the address of an empty channel to the mobile radio communication terminal 7 and sends the assigned address(step S103). The AP sends information such as a cryptographic key used for subsequent communications to the terminal 7 using the assigned channel and establishes a communication channel (step S104).

Once the channel is established, the AP acquires subscriber information such as the subscriber number of the mobile radio communication terminal 7 and sends the information to the connected local server (step S105). Thereafter, the local server supplies services to the mobile radio communication terminal 7.

When the local server detects that there is no response from the mobile radio communication terminal 7 for a predetermined time, for example, in the case where the mobile radio communication terminal 7 moves and goes out of the range covered by the AP, the local server sends a channel disconnection instruction the to the AP. Upon receipt of this channel disconnection instruction (step S106), the AP releases the channel assigned to the mobile radio communication terminal 7 (step S107) and disconnects the channel (step S108).

In the case where the mobile radio communication terminal 7 moves from an AP to another AP connected to the local server, for example, from the service range of AP (A-1) to the service range of AP (A-2) in FIG. 1, the local server 4 can detect establishment of a channel between AP (A-2) at the transfer destination and the mobile radio communication terminal 7, and in this case, the local sever 4 sends a channel disconnection instruction toAP (A-1) even before instructing channel disconnection due to the presence of the no response time above.

The interface between the AP and mobile radio communication terminal 7 can be anything if it can implement a relatively narrow range as an AP service range, but it is preferable to be an interface to which protocol supporting both data communication and voice communication is applicable and it is preferable to be an interface with small power consumption because it is mounted in the mobile radio communication terminal 7.

As such a radio interface, for example, PHS or Bluetooth can be used. In the case where Bluetooth is used, the service range of each AP is a radius of about 100 m to 10 m. In this case, the mobile radio communication terminal 7 can use a terminal with a configuration with an interface and circuit, etc. to use Bluetooth added to a telephone terminal suited to normal PDC system, etc.

Information Supply Processing

As described above, once a radio channel is established between the mobile radio communication terminal 7 and the AP, the AP sends information on the mobile radio communication terminal 7 with which the channel has been established to the host local server (FIG. 4, step S105) In response to this, the local server performs processing such as information supply on the mobile radio communication terminal 7.

As described above, in this embodiment, information is basically supplied to the mobile radio communication terminal 7 through bulletin board services and a push service that automatically distributes information and a broadcast service that supplies information continuously are combined. The communication between the mobile radio communication terminal 7 and the local server is a data communication and, as will be described later, voice data is communicated in packet format as other data.

Furthermore, in this embodiment, a bi-directional communication between the mobile radio communication terminal 7 and local server is basically implemented by the local server sending display data such as a menu screen to the mobile radio communication terminal 7 and the mobile radio communication terminal 7 selecting links included in the display screen or sending an instruction for sending data after inputting the data input area and selected area included in the display data and thereby sending data to the local server.

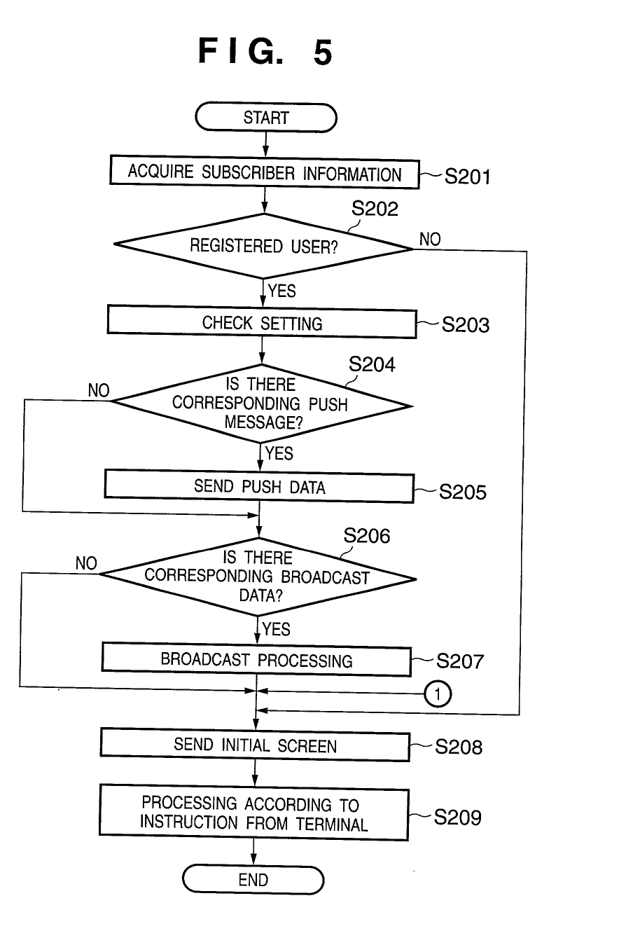

Then, the information supply processing of the local server in this embodiment will be explained using a flow chart shown in FIG. 5 and taking the operation of the local server 4 as an example.

First, in step S201, the subscriber information, for example, the subscriber number of the mobile radio communication terminal 7 is received from the AP described above. Then, the user DB 8 is searched by using this subscriber number and it is checked whether the subscriber is an already registered user (service subscriber) or not (step S202).

In the case where the check result shows that the subscriber is an unregistered user, the service initial screen display data of BBS is sent (step S208) and processing is performed according to the instruction of the terminal thereafter (step S209). Registration of the user will be described later.

On the other hand, in step S202, in the case where the subscriber is confirmed to be a registered user, it is checked whether there is any message to be pushed with reference to the user DB 8 and message DB 57 or not (step S204). More specifically, of the messages stored in the message DB 57, there are checked whether there is any message in which the subscriber of the mobile radio communication terminal 7 is set as the transmission destination and in which a “Push” is set. Settings referenced here such as setting of the transmission destination for each message will be described later.

As described above, “Push” means a service that the system forcibly sends information even if the subscriber does not access the information. Therefore, if a “Push” message exists, first the screen display data that lists the message (title) is sent to the mobile radio communication terminal 7 (step S205).

After the push message is sent, if it is detected that processing about the push message has completed, for example, an instruction for returning to the initial screen, it is checked whether there is service subscriber broadcast data or not (step S206). The broadcast data refers to data substantially and continuously supplied, for example data displayed on a character news display apparatus placed in the street.

In step S206, as in case of the check in step S204, it is determined whether there is broadcast data that can be supplied for each registered user with reference to the setting contents about broadcast data reception of the registered user, user information registered in the user DB 8 such as personal information and the setting contents of the user who is the transmission target set by the supplier of the broadcast data.

In the case where broadcast data that can be supplied exists, in step S207, screen display data indicating that the broadcast data exists is sent and then the broadcast data is supplied under instructions from the user. Details of the broadcast processing will be described later.

When the broadcast data processing is completed in such a case where a broadcast data reception completion instruction is received or where a response of not receiving the broadcast data is received, data for displaying the service initial screen is sent (step S208). Thereafter, processing is performed under instructions from the terminal (step S209).

Of course, the process may move to steps S203, S204, S206, etc. depending on the instructions received through processing in step S209.

In this way, the local server 4 consults the transmission destination specification information registered in a message (or broadcast data) and the reception data setting registered by the service subscriber and supplies only the data in which these two match to the service subscriber of the mobile radio communication terminal 7 that exists in the service area of the AP (A-1 to A-3).

User Registration Processing

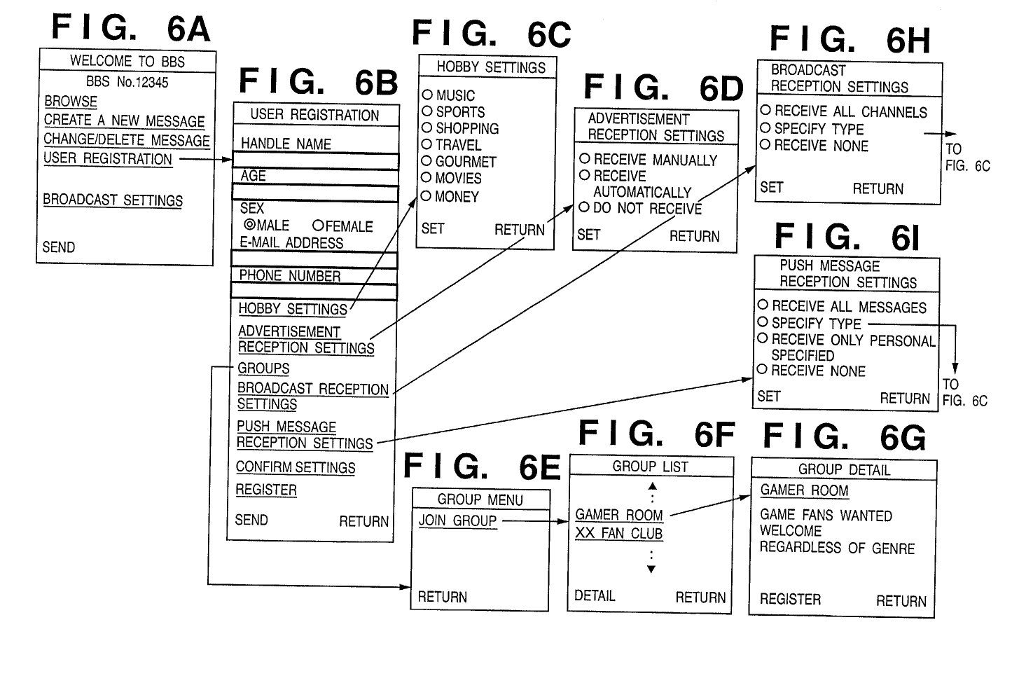

Specific user registration processing will be explained using FIGS. 6A to 6G below.

The user registration processing is performed-by selecting the “User registration” menu included in the BBS initial screen shown in step S208 in FIG. 5.

FIG. 6A shows an example of the BBS initial screen sent from the local server to the user terminal. In FIGS. 6A to 6G, underlined characters (lines) indicate links. By selecting the line and pressing a given key of the terminal assigned, for example, to “Send” displayed on the last line of the menu, a request for the display data of another menu screen (submenu) associated with the link will be sent to the local server and the local server will send the display data corresponding to the request, then another menu screen will be displayed.

That is, in FIG. 6A, if the user selects “User registration” on the terminal screen and presses the key assigned to “Send”, a request for sending the user registration screen is sent to the local server, and if the terminal side interprets and displays the user registration screen display data that the local server sends in response to this request, the user registration screen as shown in FIG. 6B is displayed.

Such a communication between the mobile radio communication terminal 7 and local server can be performed according to, for example, an HTTP protocol. In this case, as the language that the local server sends to the mobile radio communication terminal 7 and that can be interpreted on the terminal side, HTML or its instruction-extended versions can be used.

The user registration screen according to this embodiment includes the following fields:

1) Handle name setting field

Field to set a handle name (pen name) displayed on a message contributed to BBS. Enter characters.

2) Age setting field

Field to set user's age. Enter a number.

3) Sex selection field

Field to select user's sex. Select either a male or female radio button.

4) e-mail address setting field

Field to set user's e-mail. Enter alphanumeric characters.

5) Phone number setting field

Field to enter user's subscriber number. It is also possible to display the user's subscriber number notified from the AP as default setting.

6) Link to hobby settings screen

Link to screen to set fields of interest for user

7) Link to advertisement reception settings screen

Link to screen to set whether or not to receive advertisement message or set reception method

8) Link to group settings screen

Link to group setting screen such as join a registered group(s) and creation of new group, etc.

9) Link to broadcast reception settings screen

Link to broadcast reception setting screen to set whether broadcast data is received or not or type of reception, etc.

10) Link to push message reception settings screen

Link to push message reception setting screen to set whether message with push setting (auto-distribution setting) is received or not or type of reception, etc.

11) Link to registration confirmation screen

Link to be selected when final registration is performed. Link to final confirmation screen It is optional for the user to decide which of these setting fields should be set as mandatory items, but at least the handle name, phone number and e-mail address must be included in the mandatory items.

Hobby Settings

When the user performs hobby setting, the user selects the hobby setting link from the user registration screen and presses the key assigned to “Send” on the terminal. This makes the hobby setting screen (FIG. 6C) appear on the terminal as in the case of a transmission request or response of the above-described user registration screen display data.

The hobby setting screen is a screen to set the category of information that the user wants to receive or see and show a list of several roughly selected categories as shown in FIG. 6C. Each item in the list has a radio button and when the user selects an arbitrary number of radio buttons corresponding to categories of interest and presses the terminal key corresponding to “Set”, the setting contents is temporarily stored in the terminal and the user registration screen (FIG. 6B) is returned to. If the terminal key corresponding to “Return” is pressed instead of “Set”, nothing is set and the user registration screen (FIG. 6B) is returned to.

Advertisement Reception Settings

To perform an advertisement reception setting, the user selects the advertisement reception setting link from the user registration screen and presses the terminal key assigned to “Send”. This makes an advertisement reception setting screen (FIG. 6D) appear on the terminal as in the case of a transmission request or response of the above-described user registration screen display data.

The advertisement reception settings screen is a screen to set whether the user wants to have a message, which is set as “Advertisement” (advertisement message) from among the messages stored in BBS, supplied or not or set whether a push service should be validated or not. The advertisement reception setting screen in FIG. 6D is provided with the following choices and the user selects and sets one:

1) Receive manually

2) Receive automatically

3) Do not receive

1) is a setting that invalidates the push service about the advertisement message and includes an advertisement message (with a push setting) in the message list displayed when the user browses BBS.

2) is a setting that validates the push service by the local server for an advertisement message with a push setting and when the user enters the service area of the local server, automatically sends advertisement messages with push settings that match other settings to the mobile radio communication terminal 7. Of course, advertisement messages without push settings are displayed in the message list displayed when the user browses BBS.

3) is set when the user does not want to receive any advertisement message.

When the user selects one radio button corresponding to the item to be specified and presses the terminal key corresponding to “Set”, the setting contents is temporarily stored in the terminal and the user registration screen (FIG. 6B) is returned to. If the terminal key corresponding to “Return” instead of “Set” is pressed, nothing is set and the user registration screen (FIG. 6B) is returned to.

Group Settings-Join a New Group(s))

When the user carries out a group setting, the user selects a group setting screen link from the user registration screen (FIG. 6B) and presses the terminal key assigned to “Send”. This makes the group settings screen (FIG. 6E) appear on the terminal as in the case of a transmission request or response of the above-described user registration screen display data.

The group settings screen is a screen used when the user joins a group registered in BBS, creates a new group or edits/deletes a group created by the user.

In this embodiment, a “group” is a group of registered users and no restrictions by hobby setting item, etc. are imposed when a user joins the group. A group can be specified, for example, as the transmission destination of a message created.

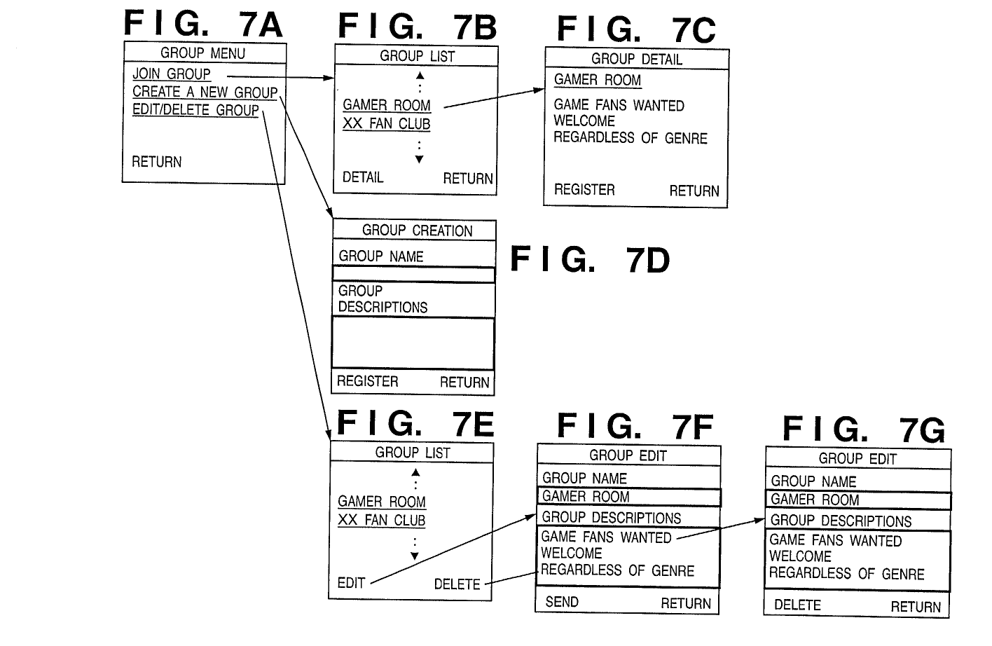

As shown in FIG. 6E, the group menu screen shows only a new joining link for a user to newly joins the group. On the other hand, when a registered user calls up the group setting screen from a predetermined screen, a group creation link to be selected when a new group is created and a group edition/deletion link to be selected when the group created by the user is edited or deleted are displayed in addition to the new joining link as shown in FIG. 7A.

When an unregistered user wants to join a new group, the user selects the new joining link in FIG. 6E and a list screen (FIG. 6F) to specify a group appears. The group list screen shows a list of all group names registered in the local server as a link.

Of course, it is also possible to display, not the screen showing the list of all groups, but a group name obtained by narrowing the search range through a screen for searching names in alphabetical order beforehand.

When the user selects a group name of interest from among group names shown in the group name list and presses the key assigned to “Detail”, a predetermined brief introduction to the group (FIG. 6G) is displayed. Here, if the user presses the key assigned to “Register”, information that the user wants to get registered in the group displayed is temporarily stored in the terminal and the user registration screen (FIG. 6B) is returned to.

In the case where a registered user newly joins the group, as shown in FIGS. 7B and 7C, the screen displayed on the terminal is the same as in the case of the unregistered user, but different in that when the key assigned to “Register” in FIG. 7C is pressed, a registration instruction is sent to the local server. This is because in the case of an unregistered user, registration itself may be canceled by the time definitive registration is instructed.

Group Setting-Create a New Group

Here, other group settings to be carried out by a registered user will also be explained. Selecting the new group creation link (“Create new group”) will display the group creation screen (FIG. 7D) to enter a group name and group descriptions, which are displayed on the group list display screen and detail display screen (FIGS. 6F, 6G, 7B and 7C).

When the user enters a group name and group descriptions on this screen and presses the key assigned to “Register”, the input data is sent to the local server and registered in the group DB provided in a predetermined area of the HDD 53 together with the subscriber number of the registrant.

Group Setting-Edit/Delete Settings

On the other hand, when the link to edit/delete an existing group (“Edit/delete group”) included in the group setting screen (FIG. 7A) is selected, the local server 4 searches the group DB using the subscriber number of the registered user and transmits the list display data of the group created by the registered user. The registered user selects a desired group to be edited or deleted from this list display screen (FIG. 7E) and presses the key assigned to “Edit” or “Delete”.

When “Edit” is instructed (FIG. 7F) or when “Delete” is instructed (FIG. 7G), the local server 4 reads the name of the specified group and group descriptions from the group DB and sends it together with the display screen data. The group name and group descriptions are displayed on the terminal and in the case of editing, the user edits this data and presses the key assigned to “Send” to send the changed data to the local server. The local server overwrites the group DB with the received data.

On the other hand, if the key corresponding to “Delete” is pressed in FIG. 7G, the local server deletes the record on the relevant group from the group DB.

Back in FIGS. 6A to 6G, if an unregistered user carries out various settings, selects a “Register” link in FIG. 6B and presses the key assigned to “Send”, when a confirmation message “Do you register?”, etc. is displayed and “Register” is instructed again, the mobile radio communication terminal 7 sends the subscriber number and each setting item to the local server. Of course, it is also possible to configure the system so that a list of the setting contents is displayed to the user together with the message “Do you register?”.

Like this, if the user DB is changed as in the case where an unregistered user is newly registered or a registered user has changed the registered contents, etc., the relevant local server notifies the central processing server 1 of the change contents. The central processing server 1 reflects the change contents in its own user DB 2 and at the same time instructs local servers other than the notification source to reflect the change in the user DB owned by each local server. This maintains synchronization between all user DBs.

Reception Settings of Broadcast Messages

When the user performs settings regarding reception of broadcast data, the user selects a broadcast reception setting screen link from the user registration screen (FIG. 6B) and presses the terminal key assigned to “Send”. This makes the broadcast reception settings screen (FIG. 6H) appear on the terminal as in the case of a transmission request or response of the above-described user registration screen display data.

The broadcast reception settings screen is provided with the following three choices and the user can carry out settings by selecting a desired choice and pressing the key corresponding to “Set”:

1) Receive all channels that can be received

2) Receive only specific type of channel

3) Receive no broadcast data

However, if “Specify type” is selected, the above-described hobby settings (FIG. 6C) screen is displayed and the setting is completed by specifying a category of the broadcast data that the user wants to receive.

Reception Settings of Push Message

In the case where the user carries out settings regarding reception of a push message, the user selects a push message reception settings screen link from the user registration screen (FIG. 6B) and presses the terminal key assigned to “Send”. This makes a push message reception settings screen (FIG. 6I) appear on the terminal as in the case of a transmission request or response of the above-described user registration screen display data.

The push message reception settings screen is provided with the following four choices and the user can carry out settings by selecting a desired choice and pressing the key corresponding to “Set”:

1) Receive all push messages

2) Receive only a push message of a specific type

3) Receive only a push message directed to user

Personally Specified

4) Receive no push message

Of these four, if the user sets “Receive only personally specified push message”, the user will only receive the message for which a specific individual (the user) is set as the transmission destination from among the messages for which a push setting (auto distribution) is set in the message creation processing, which will be described later.

Furthermore, in the case where “Specify type” is selected, the above-described hobby settings screen (FIG. 6C) is displayed and the category of a push message that the user wants to receive is specified and the setting ends.

Message Creation Processing

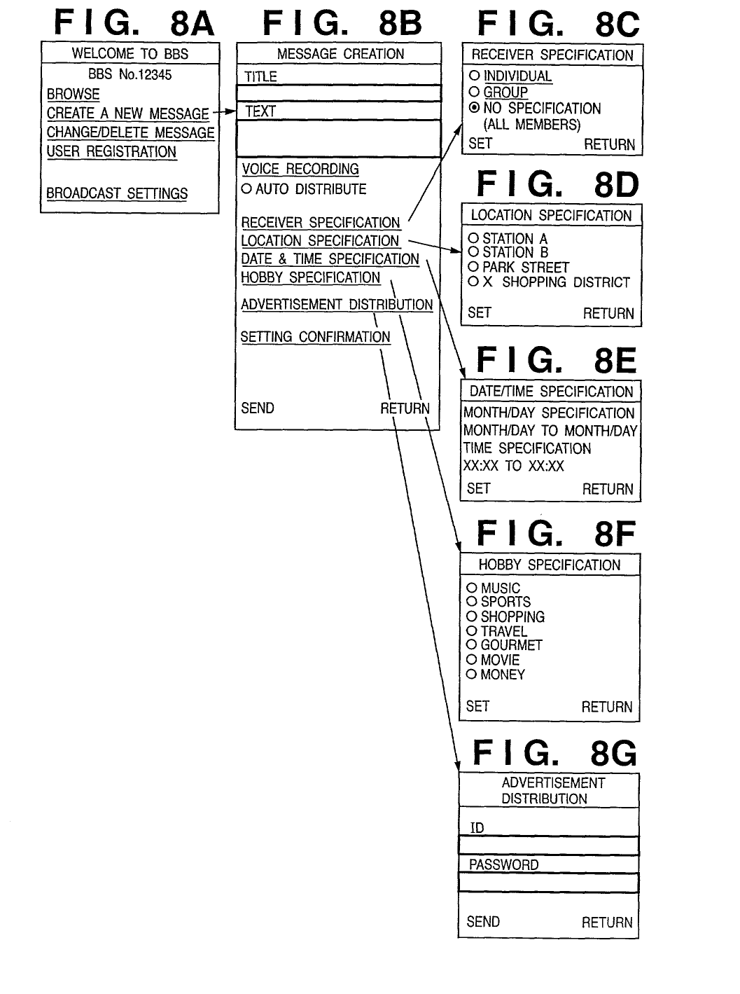

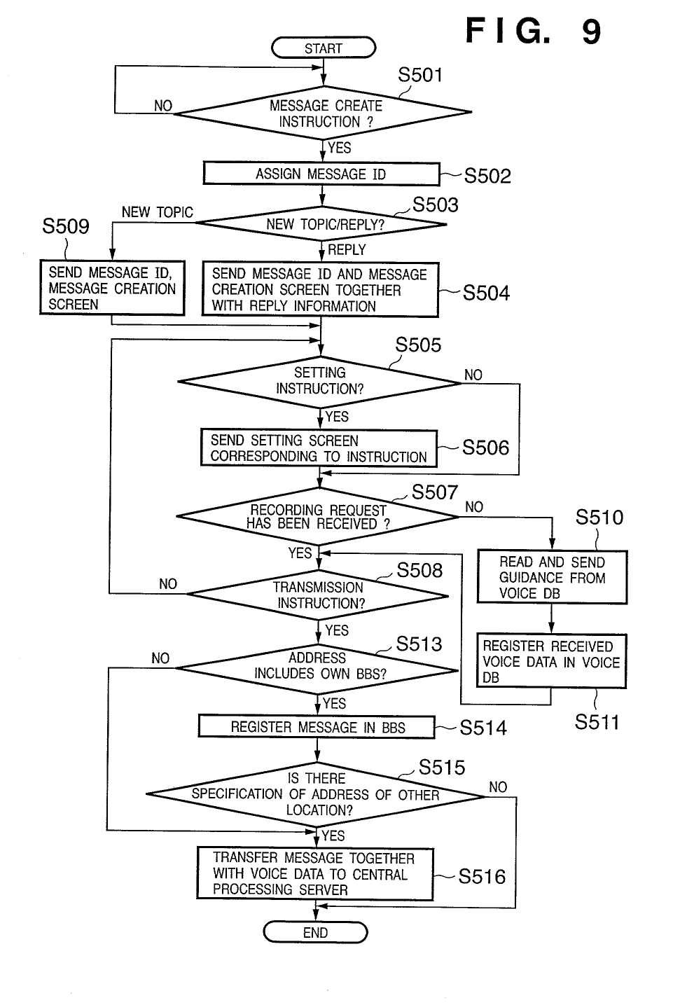

Then, the message creation processing will be explained by using FIGS. 8A to 8G showing screen display examples in the mobile radio communication terminal 7 and FIG. 9, which is a flowchart showing processing of the local server. In the following explanation, message creation processing between the mobile radio communication terminal 7 and local server 4 will be described as an example. However, the local servers in this system will also operate in the same way on a message creation request from an apparatus, which can access this system over the Internet

A message is created in the following cases:

1) Create a new topic

2) Respond to a message shown during browsing of BBS

First, creation of a new topic will be explained using the screen display example in FIGS. 8A to 8G and the flow chart in FIG. 9.

When a message creation link is selected from the service initial screen (FIG. 8A) (step S501), the local server 4 assigns a message ID to the new message (step S502). Then, since the message is creation of a new topic (step S503), the display data of the message creation screen will be sent together with the message ID (step S509).

As a result, the message creation screen (FIG. 8B) is displayed on the terminal.

The message creation screen is provided with the following:

1) Title field

Character input field to input message title

2) Text field

Character input field to input message text

3) Voice recording link

Link selected to attach voice to message

4) Push setting field (“auto distribution”)

Field set to attach push attribute to message created

5) Receiver specification screen link

Link selected to specify receiver of message created by individual or group, etc.

6) Location specification screen link

Link selected to specify receiver of message created by location (local server)

7) Date & time specification screen link

Link selected to only send message created during specific period

8) Hobby specification screen link

Link selected to specify receiver of message created according to hobby setting set by receiver

9) Advertisement distribution setting screen link

Link selected to handle message created as advertisement in system

10) Setting confirmation screen link

Link selected to confirm contents of setting carried out on message created before sending message

Selection of each link is detected by the local server (step S505) and the local server sends the setting screen corresponding to the selected link (step S506).

Creation of Title and Text

The title and text are input by entering characters from the terminal into each field. The recording link is a link selected to attach voice data to a message and when the local server detects the selection of the recording link (step S507), the local server reads a voice guidance to urge recording from voice DB 53 and sends it to the mobile radio communication terminal 7 (step S510).

This voice guidance (packet data) is replayed as a voice signal in the mobile radio communication terminal 7 and notified to the user. The user records speech from a microphone according to the guidance. This voice is digitized inside the terminal, coded if necessary and sent to the local server 4 as voice packet data. This voice packet data is sent with a message ID and an identifier indicating that the packet is a voice packet included in the header.

Upon receipt of this voice packet, the local server 4 converts the voice packet to a readable format according to the message ID and registers it in the voice DB 53 (step S511). The mobile radio communication terminal 7 sends voice data and then sets a voice flag (described later) in the message data.

Various Settings

The push settings field is selected to carry out auto distribution from the local server to a transmission target subscriber using the above-described push service (select a radio button).

When the receiver specification screen link is selected, the receiver specification screen in FIG. 8C is displayed. The receiver specification screen is provided with an individual specification link, which is selected to specify a specific individual, a group specification link, which is selected to specify a group and a default all-member specification field.

If the individual specification link (“individual”) is selected here, an address setting screen, which is not shown in the drawing, is displayed and the transmission destination is set to a specified individual by inputting information with which the receiver is identifiable such as the receiver's e-mail address, handle name and subscriber number. When individual specification is performed, by combining the “individual” designation with the location specification, which will be described later, such a message will be browsed by the specified individual only when the specified individual enters the service area of the specified local server.

Furthermore, if the group specification link is selected, a group list screen as shown in FIG. 6F is displayed and selecting a desired group from the relevant screen will select the subscriber who belongs to the selected group as the transmission target.

Furthermore, if the location specification screen link is selected on the message creation screen, the location specification screen shown in FIG. 8D is displayed.

The location specification screen shows a service area of a local server that belongs to this system. It is possible to specify an arbitrary number of service areas and register messages in BBS of another location by specifying the location. In this case, as will be described later, a message is distributed by transferring the message from the local server to the central processing server 1 and by the central processing server 1 judging the local server corresponding to the location specified as the destination of the message.

Furthermore, when specifying the location, it is also possible to make it selectable whether a message should be registered or not in the BBS supplied by the local server that created the message. It is further possible to specify the location using a number assigned to each BBS (local server). The BBS number is displayed as “BBS No. XXXX” on the initial screen in FIG. 8A, for example.

Selecting the date & time specification screen link shows the date & time specification screen shown in FIG. 8E. The date & time specification screen is provided with the month/date input field specified in day units and the hour input field specified in hour and minute units.

The message with these fields filled with settings is only sent to the users who exist in the service area of the local server (specified local server in the case where the location is specified) in the specified date/time range.

If the hobby specification link is selected, the hobby specification screen shown in FIG. 8F is displayed. This screen is the same as the hobby setting screen during the user setting and if an arbitrary number of categories are selected from the categories displayed on this screen, the subscribers who have selected the selected categories in the hobby setting become the message transmission targets.

Furthermore, if the advertisement distribution setting screen link is selected, the advertisement distribution authentication screen in FIG.8G is displayed. The advertisement distribution authentication screen is provided with an ID input field and password input field where the user ID number and password for the advertisement distribution registered beforehand are entered, respectively. The ID and passwords entered are sent to the local server together with the subscriber number by pressing the key assigned to “Send” and the local server searches the user DB based on the subscriber number and performs authentication against the registered ID and password. If the authentication is performed correctly, a message display data such as “Registered as advertisement message” is sent to the mobile radio communication terminal 7. Upon receipt of this message, the mobile radio communication terminal 7 sets an advertisement flag (described later) corresponding to the message being created.

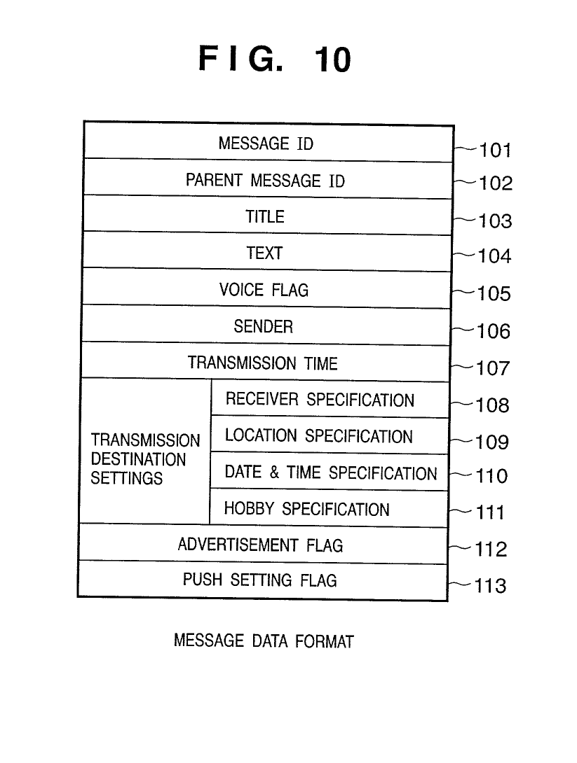

On the message creation screen in FIG. 8B, if the key assigned to “Send” is pressed, a message with the configuration as shown in FIG. 10 is sent to the local server 4.

In FIG. 10, the message data has the following fields:

1) Message ID field 101

Field to store message ID assigned from local server 4

2) Parent message ID field 102

Field to store message ID of message (parent message), which is link source, in message linked with another message such as reply

3) Title field 103

Field to store message title

4) Text field 104

Field to store message text

5) Voice flag 105

Field to indicate whether message comes with recorded voice or not. This field is set if voice is recorded when message is created.

6) Sender field 106

Field to store subscriber number of sender when message is sent from a mobile radio communication terminal 7. When the message is stored in the message DB, the subscriber number is converted to a handle name by the local server using the user DB 8.

7) Transmission time field 107

Field to store date/time extracted from a clock inside mobile radio communication terminal 7 when message is sent

8) Receiver specification field 108

Field to store contents specified on receiver specification screen (FIG. 8C) when message is created

9) Location specification field 109

Field to store contents specified on location specification screen (FIG. 8D) when message is created

10) Date & time specification field 110

Field to store contents specified by date & time specification screen (FIG. 8E) when message is created

11) Hobby specification field 111

Field to store contents specified by hobby specification screen (FIG. 8F) when message is created

12) Advertisement flag 112

Flag set for message correctly authenticated via advertisement distribution setting screen (FIG. 8G) when message is created

13) Push setting flag 113

Flag set for message with push setting on message creation screen (FIG. 8B)

Upon receipt of a message in such a format, the local server 4 first refers to the location specification field 109 and confirms whether the received message should be stored in the message DB 57 or not, that is, whether only other locations are specified or not (step S513).

If specification of only other locations is not the case, that is, when it is decided that the message needs to be registered in the message DB 57, the received message is registered in the message DB 57 (step S514).

Then, if other locations are specified (step S515), the message data is transferred to the central processing server 1. In this case, if a check of the voice flag 105 in the message shows that voice data is attached to the message data, the voice data is read from the voice DB 53 and transferred to the central processing server 1 together with the message data (step S516).

As will be described later, upon detection of reception of a message, the central processing server 1 checks its location specification field 109 and identifies the local server to which the message is to be transferred using the location specification contents and local server DB 63 (FIG. 3). Then, the message is transferred to the specified local server. In the case where a plurality of specified local servers is specified, the message is copied and transferred to each local server.

Browsing Processing

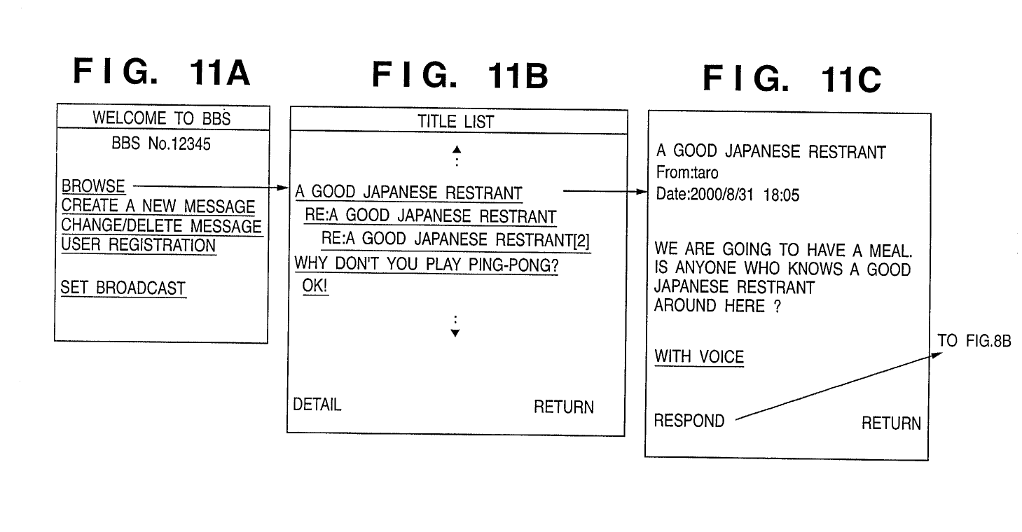

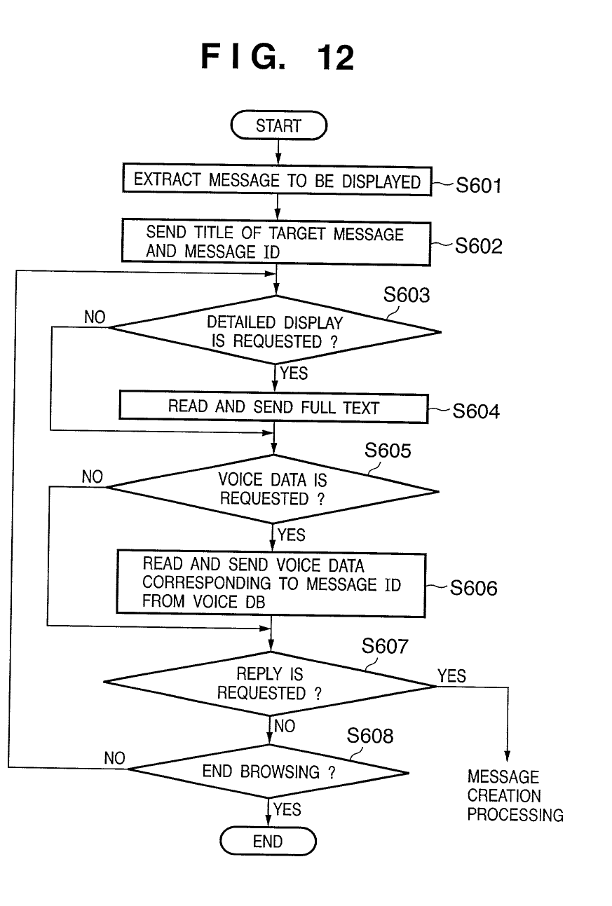

Then, browsing processing and creation of a reply message from the browsing processing will be explained by using FIG. 9, FIG. 10 and FIG. 12. FIGS. 11A to 11C are terminal screen display examples during browsing and FIG. 12 is a flow chart showing browsing processing in the local server.

When browsing is performed from the initial screen (FIG. 11A), a browsing instruction is sent to the local server 4 by selecting a browsing screen link “Browse” in the initial screen. In response to this instruction, the local server 4 searches the user DB 8 using the subscriber number of the mobile radio communication terminal 7 and compares the setting contents of the relevant subscriber and the setting contents of the message in the message DB, and thereby extracts the message in which both conditions match (step S601).

Then, the local server 4 sends the title and message ID of the message to be displayed to the mobile radio communication terminal 7 (step S602). As a result, the message title is displayed on the screen of the mobile radio communication terminal 7 (FIG. 11B). As explained by using FIG. 5, in the case where there is a push message that matches the user setting in the message DB, when the mobile radio communication terminal 7 enters the service area and a radio channel is established, the same extraction processing as that in step S601 is performed on the message with a push setting and a title display screen as shown in FIG. 11B is displayed.

When a desired title is selected from the title display screen in FIG. 11B and the key assigned to “Detail” is pressed (step S603), a detailed display request and message ID of the message requested to be displayed are sent from the mobile radio communication terminal 7 to the local server 4. Upon receipt of this, the local server 4 searches the message DB 57 using the message ID and sends items necessary for a predetermined detailed display format such as message text, voice flag, transmission date/time, sender handle name, etc. to the mobile radio communication terminal 7 (step S604). As a result, the whole text of the message is displayed on the screen of the mobile radio communication terminal 7 (FIG. 11C).

In this embodiment, the title, handle name of the sender, transmission date/time and text are displayed on the whole text display screen shown in FIG. 11C, and in the case where message voice recording is linked, a link to the voice data (“With voice”) is displayed.

If the user selects the link to the voice data from the whole message text display screen (step S605), the local server 4 reads the voice data having the same ID as the message ID displayed from the voice DB 53 and sends it to the mobile radio communication terminal 7 (step S606). The mobile radio communication terminal 7 replays the received voice data and outputs the voice attached to the message through the speaker of the mobile radio communication terminal 7.

On the other hand, if the user presses the key assigned to “Respond” from the whole message text display screen (step S607), the process transitions to the message creation processing shown in FIG. 9. In this case, in step S503 in FIG. 9 it is detected that the message to be created is a reply message.

Then, the local server 4 sends the message ID assigned to the new message in step 502, the display data of the message creation screen shown in FIG. 8B, reply information such as the message ID of the parent message, reply title (for example, the parent message title with “Re:” added) and transmission destination specification information such as location specification information in the parent message (step S504).

As a result, the mobile radio communication terminal 7 displays a message creation screen with reply information embedded. Of course, in step S504, it is also possible to send only the display data of the message creation screen and message ID and acquire reply information by an application on the mobile radio communication terminal 7 side. Since the subsequent processing in creation of a reply message (in and after step S505 in FIG. 9) is the same as the processing when a new topic is created, further explanations will be omitted.

Back in FIG. 12, if no reply request is detected in step S607, it is checked in step S608 whether a browsing end instruction (e.g., pressing the terminal on-hook key) is issued or not and if the browsing end instruction is issued, the processing is finished and, for example, the display data of the initial screen is sent. If no browsing end instruction is detected, the process goes back to step S603 and a detailed display request will be detected.

Change and Deletion Processing of Message

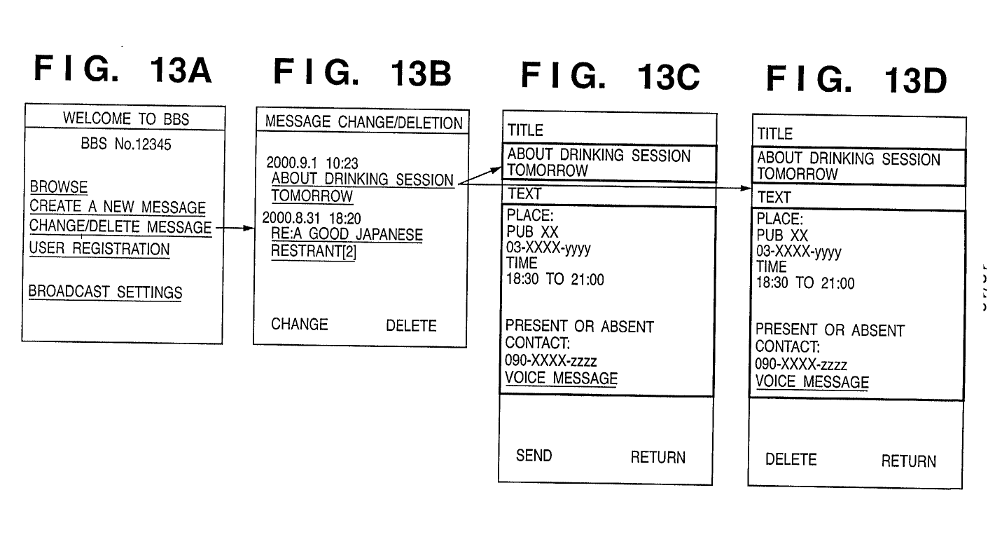

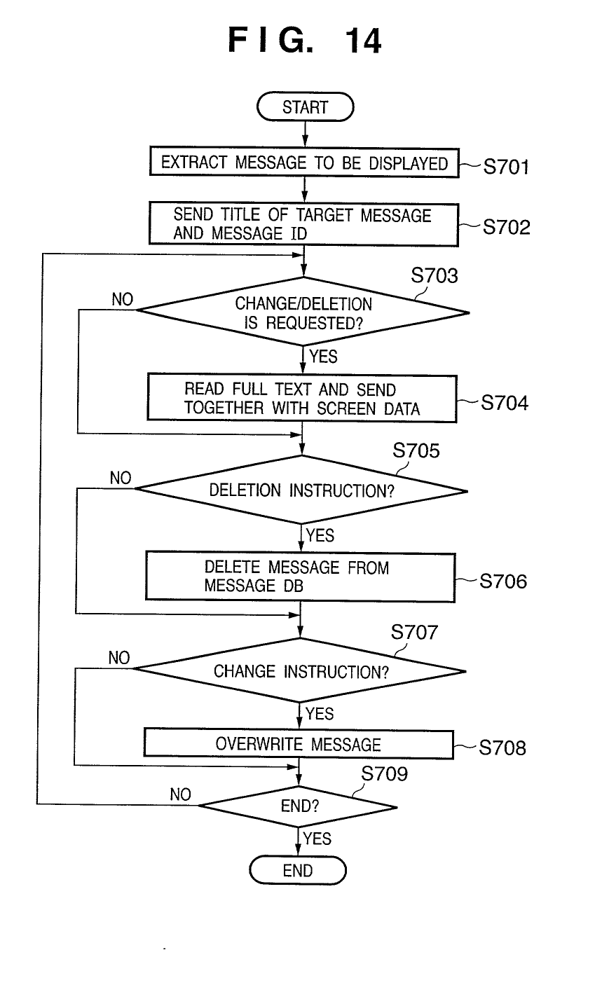

Then, message change and deletion processing will be explained using the display screen examples in FIGS. 13A to 13D and FIG. 14 showing the processing in the local server.

For example, if the message change/deletion link is selected from the initial screen (FIG. 13A), the mobile radio communication terminal 7 sends the subscriber number and a message change/deletion processing request to the local server 4. In response to this instruction, the local server 4 searches the message DB 57 using the subscriber number of the mobile radio communication terminal 7 and extracts the message registered by the relevant subscriber (step S701).

Then, the local sever 4 sends the title of the message to be displayed and message ID to the mobile radio communication terminal 7 (step S702). As a result, the message title is displayed on the screen of the mobile radio communication terminal 7 (FIG. 13B).

When a desired title is selected from the title display screen in FIG. 13B and the key assigned to “Change” or “Delete” is pressed (step S703), the mobile radio communication terminal 7 sends a change or deletion request and the ID of the message requested to be changed or deleted to the local server 4. The local server 4 that receives this searches the message DB 57 using the message ID and sends items necessary for a predetermined detailed display format, for example, message text, voice flag, transmission date/time, sender handle name, etc. to the mobile radio communication terminal 7 (step S704). As a result, the whole text of the message appears on the screen of the mobile radio communication terminal 7 (FIG. 13C or 13D).

In this embodiment, the title, transmission date/time and text are displayed on the whole text display screen shown in FIGS. 13C and 13D, and in the case where message voice recording is linked, a link to the voice data (“voice message”) is displayed.

If the user selects the link to the voice data, which is not shown in the figure, from the whole text display screen of the message at the time of a change, the same voice recording processing as that in step S510 and S511 in the new message creation processing explained using FIG. 9 is performed and the voice DB 53 is overwritten with the voice data received from the mobile radio communication terminal 7.

Likewise, if the user selects the link to the voice data not shown in the figure from the whole message text display screen (FIG. 13D) at the time of deletion, the same voice replay processing as the replay processing (step S606) of the voice data in the browsing processing explained using FIG. 12 is performed and it is possible to audit voice data attached to the message by the mobile radio communication terminal 7.

Moreover, though not described in the figure, it is also possible to provide a link to newly add voice data on the changed whole message text display screen at the time of change. In this case, selecting the voice addition link will perform the same voice recording processing as that in step S510 and S511 in the new message creation processing explained using FIG. 9 and the local server newly registers the voice data received from the mobile radio communication terminal 7 in the voice DB 53.

Back in FIG. 14, in step S705, it is checked whether a deletion instruction is received from the whole message text display screen at the time of deletion and if the deletion instruction is received, the message being displayed is deleted from the message DB 57 (step S706)

Furthermore, in step S707, if the key assigned to “Send” is pressed from the whole message text display screen at the time of change and the message is sent (step S707), the message DB 57 is overwritten with the received message (step S708).

In step S709, it is checked whether a change/deletion end (e.g., pressing the terminal on-hook key) is instructed or not and if the change/deletion end is instructed, the processing is finished and the display data of the initial screen is sent. If no end instruction is detected, the process goes back to step S703 and a change/deletion processing request is detected.

Message Transfer Processing

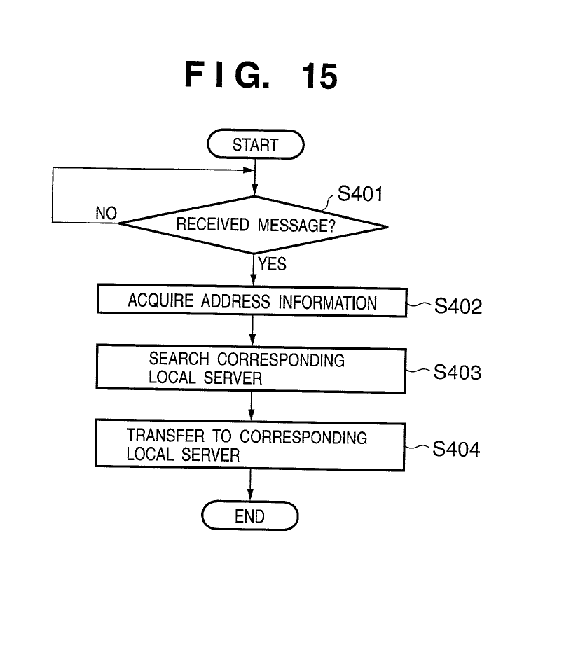

Then, the message transfer processing carried out by the central processing server 1 will be explained by using the flow chart shown in FIG. 15.

As described above, it is possible to specify the location of the receiver about individual messages created. That is, in FIG. 1, by the mobile radio communication terminal 7 located in the service area of zone A creating a message with location specification corresponding to zone B and/or zone C, it is possible to specify so that no message is supplied to the subscribers who exist (or enter in the future) in zone A and the message is supplied only to the subscribers who exist (or enter in the future) in zone B and/or zone C (of course, the message is not supplied to subscribers who exist in zone B and/or zone C but do not match other conditions set in the message).

As explained by using FIG. 9, upon receipt of a new message, the local server checks its location specification field and if any place other than its own location is specified, the message is transferred to the central processing server 1.

Upon receipt of the message (step S401), the central processing server 1 checks the location specification field (step S402) and specifies the local server to which the message is to be transferred using the location specification contents and the local server DB 63 (FIG. 3) (step S403). Then, the message is transferred to the local server as the transfer destination (step S404). If there are a plurality of transfer destinations, the message is copied and transferred to each local server.

Each local server that has received the message from the central processing server 1 stores the message received in the message DB. As described before, if voice data is attached to the message, voice data is also attached to the message transferred from the local server to the central processing server 1. When the message is transferred from the central processing server 1 to the local server as the transfer destination, the message with voice data attached will be transferred with voice data attached.

Each local server that has received the message with voice data attached stores the attached voice data in its own voice DB 53 and stores other character messages in the message DB 57.

Broadcast Processing-Data Setting

Next, the broadcast processing will be explained. As described above, this system can supply information to the user by broadcasting. Broadcasting is a service of supplying display (or voice) data virtually continuously as in the case of radio, TV or character broadcasting.

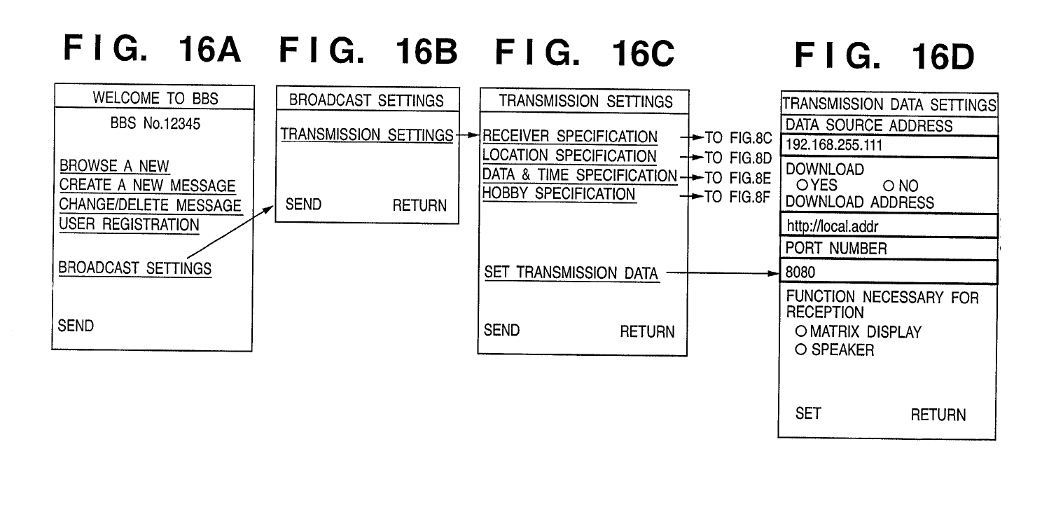

In order to provide such a broadcast service, it is necessary to set the local server so that the local server can recognize data to be broadcast beforehand. Therefore, the setting of broadcast data will be explained using FIGS. 16A to 16D first. In the following explanations, the case of setting at the mobile radio communication terminal 7 will be explained as an example, but as in the case of message processing, this setting can also be performed from devices connected to the Internet such as the information supply server 3.

First, when a link to the broadcast setting screen provided on the initial screen (FIG. 16A) is selected and the mobile radio communication terminal 7 presses the key assigned to “Send”, the broadcast setting screen is displayed (FIG. 16B). Selecting the transmission setting screen link (“Transmission setting”) from the broadcast setting screen and pressing the key corresponding to “Send” will display the transmission setting screen (FIG. 16C).

As in case of the message creation screen (FIG. 8B), the transmission settings screen is provided with a receiver specification screen link, location specification screen link, date & time specification screen link and hobby specification screen link. Screen display and the setting contents on each screen when these links are selected are as described above using FIGS. 8C to 8F, and therefore overlapping explanations will be omitted.

The transmission setting screen is further provided with a transmission data setting screen link and selecting this link and pressing the key corresponding to “Send” will display the transmission data setting screen (FIG. 16D).

The transmission data settings screen is provided with:

1) Data source address input field

Field to specify supply source of broadcast data, for example IP address

2) Download necessary/unnecessary setting field

Field to specify whether there is software to be downloaded to mobile radio communication terminal 7 separately in order for mobile radio communication terminal 7 to process broadcast data

3) Download address input field

Field to input information to specify download software stored in local server, for example, URL, when “Necessary” is set in download necessary/unnecessary setting field

4) Port number field

Field to enter port number to specify application program of mobile radio communication terminal 7 that processes broadcast data

5) Terminal mandatory function specification field

Displaying fine data such as stock price at mobile radio communication terminal 7 requires dot matrix display on terminal side. Moreover, when voice data is broadcast, it is not possible to hear replayed voice if the speaker is not on the terminal side. Therefore, the function (equipment) necessary on the mobile radio communication terminal 7 side is specified to process data to be broadcast in this field.

When the key corresponding to “Set” on the transmission data setting screen is pressed, the setting contents of each setting screen linked from FIG. 16C and set value corresponding to each setting item included in FIG. 16D are sent to the local server. The setting contents is stored in the local server HDD 58.

When the setting is performed, the local server accesses the address set in the source data address field and starts to receive broadcast data. Furthermore, the subscriber who performed broadcast setting transfers an application program necessary for FTP etc. to the address in the local server specified for the download address field.

Broadcast Data Processing

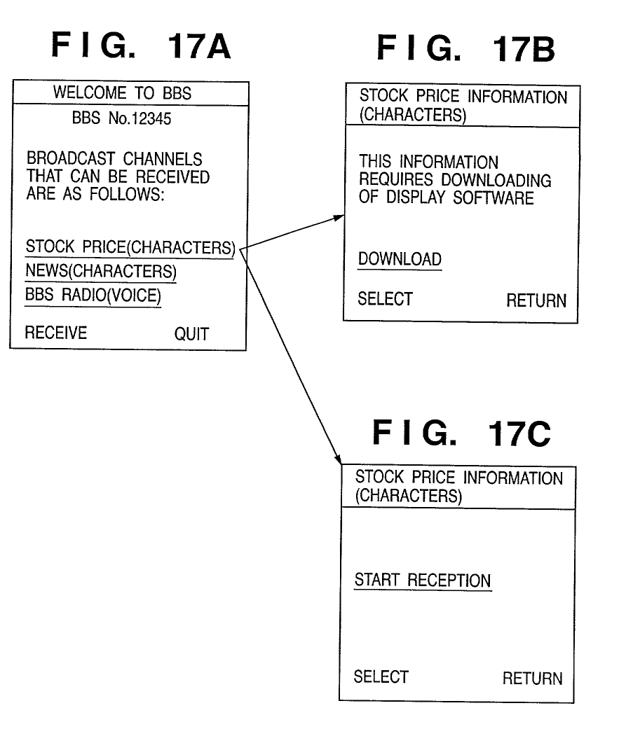

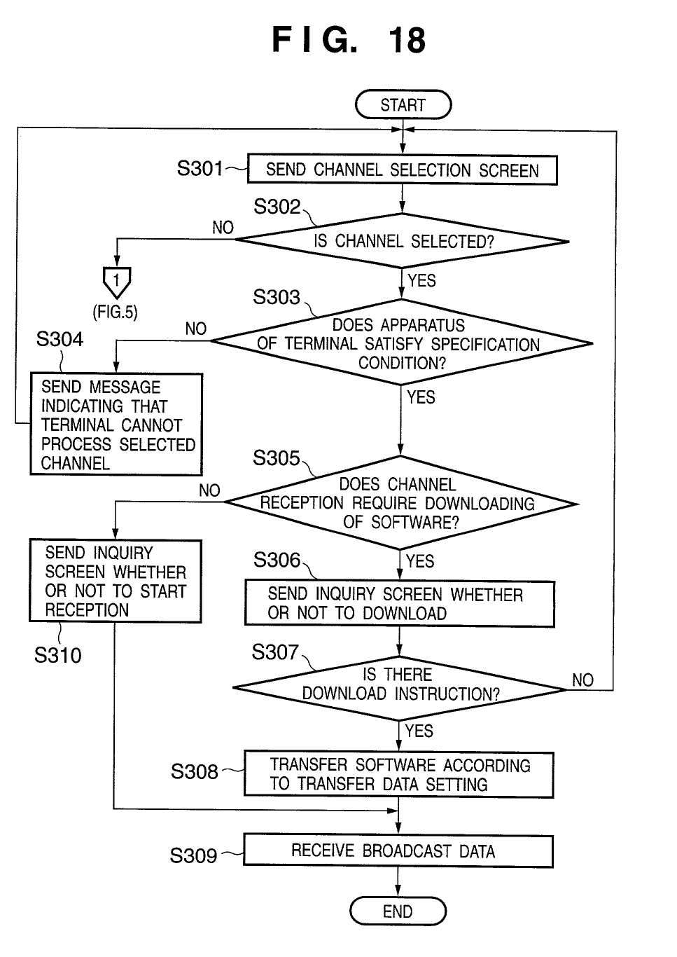

Then, the broadcast operation in this system will be explained using the screen display examples in FIGS. 17A to 17C and the flow chart in FIG. 18 to explain broadcast processing by the local server.

As explained using FIG. 4, when the mobile radio communication terminal 7 enters the service range of an AP which belongs to this system, a radio channel is established between the mobile radio communication terminal 7 and the AP and the subscriber number of the mobile radio communication terminal 7 is sent from the AP to the local server after the establishment of the radio channel.

Then, as explained in FIG. 5, the local server searches the user DB 8 using the subscriber number received from the AP and authenticates that the subscriber is a registered user. Then, when processing about the push message is completed, broadcast data processing is performed (steps S206 and S207).

More specifically, of the broadcast data preset at the local server, the display data of the channel selection screen (FIG. 17A) about the broadcast data that matches the subscriber setting of the mobile radio communication terminal 7 is sent (step S30) . This display data also includes the channel number information of each broadcast channel.

The channel setting screen shows broadcast channels that the user can receive and the individual radio buttons are placed next to the broadcast channels. When the user wants to receive one of these channels, the user selects the radio button corresponding to the one channel and presses the key corresponding to “Receive”.

This channel selection is detected by the local server (step S302) and the local server reads the setting contents about the selected broadcast data from the HDD 58 and checks whether the hardware necessary for processing of the selected broadcast data is mounted in the user's terminal, that is, mobile radio communication terminal 7 or not (step S303). This check, for example, can be performed by the local server sending an inquiry command to the mobile radio communication terminal 7 and the mobile radio communication terminal 7 checking the spec of the terminal and sending back in response to this command.

As a result of the check, if the mobile radio communication terminal 7 does not have the dot matrix display even if the broadcast data requiring the dot matrix display has been selected, for example, a message that processing of the selected broadcast channel is not possible by the terminal is sent to the user (step S304) and the channel selection screen is returned to.

When the terminal 7 satisfies hardware-like requirements, it is then checked whether an application program necessary for processing of the broadcast data is required or not (step S305). This check references the contents of the broadcast data setting and checks whether the application program is necessary or not and also checks whether the mobile radio communication terminal 7 has the necessary application program or not.

Whether the mobile radio communication terminal 7 has the necessary application program or not can be checked, for example, by registering the application program downloaded in the past in the record of the user DB 8 for each user and referencing the user DB 8 in the processing in step S305.

In step S305, if it is decided that processing the selected broadcast data requires the mobile radio communication terminal 7 to download the software, the message notifying that and an inquiry screen (FIG. 17B) having the download link are sent (step S306).

When the user selects the download link (“Download”) and presses the key corresponding to “Select”, a download request is sent from the mobile radio communication terminal 7 to the local server 4 (step S307) and the application program is transferred from the local server 4 to the mobile radio communication terminal 7 according to a protocol such as HTTP and FTP (step S308). When the transfer of the application program is completed, the local server 4 registers the transferred application in the user DB. When the application program is transferred, the mobile radio communication terminal 7 starts to receive the broadcast data (step S309).

Furthermore, in step S305, if it is decided that the mobile radio communication terminal 7 can process broadcast data without downloading the software, inquiry screen data as to whether reception should be started or not is sent (step S310). When the mobile radio communication terminal 7 displays this data (FIG. 17C), the user selects “Start reception” on the screen and presses the key corresponding to “Select”, the mobile radio communication terminal 7 starts to receive broadcast data using the broadcast channel number received together with the display data of (FIG. 17A) (step S309).

As described above, the local server 4 always receives already set broadcast data and continues to send this broadcast data using a predetermined channel. Furthermore, the broadcast data is sent to the port number specified in the port number field of the broadcast data setting (port number assigned to the application program that performs broadcast data processing in the mobile radio communication terminal 7).

Thus, the mobile radio communication terminal 7 performs processing such as display based on the broadcast data received by the broadcast data processing application program.

As explained above, since it is possible to specify various transmission destination conditions other than addresses for the created message, it is possible to supply information with the limited time and location, for example, sending a message so that only “subscribers who are in the premises of station A between AM 10:00 to 1:00 PM on September 8” can browse. Or since it is also possible to specify personal information such as a taste of a registered subscriber, it is also possible to specify, for example, “subscribers who are in the premises of station B and who are interested in sports”, etc. In this way, viewed from the information supplier side, it is possible to supply information narrowing the range of the target and perform more effective advertisement when distributing advertisement, etc.

Furthermore, even with a message other than advertisement, if a message set so that “a message is pushed when a specific person comes to a specific place” is created, it is also possible to use the message in such a way that the contact address will be notified when the person who is late for an appointment arrives at the meeting place.

Moreover, when receiving information, specifying the information that one wants to receive (browse) beforehand makes it possible to acquire only the desired information, and therefore it is less likely to see unnecessary information and it is possible to acquire necessary information effectively.

As explained above, the information supply system according to the present invention allows both the party who supplies information and the party who receives the information to specify the receiver of the information and specify desired information, making it possible to acquire effective information supply and efficient information acquisition.

What is claimed is:

1. An information supply system that has at least one local server means having a service area with a predetermined range and a central server means for connecting between said local server means and supplies pre-stored information to a service subscriber terminal existing in said service area, comprising:
information database means for storing information with each of which a transmission destination specification condition is associated;
subscriber database means for storing an information reception condition set for each of said service subscriber terminals;
information selecting means for comparing said information reception condition corresponding to said service subscriber terminal existing in the service area of said local server means with said transmission destination specification condition using said information database means and said subscriber database means and selecting only information having said transmission destination specification condition that satisfies said information reception condition; and
information supplying means for presenting only the information selected by said information selecting means to said service subscriber terminal existing in said service area.

2. The information supply system according to claim 1, wherein said information database means, said information selecting means and said information supplying means are provided in each of said local server means.

3. The information supply system according to claim 1, wherein said transmission destination specification condition includes at least one of location specification conditions that specify the local server means as the transmission destination, period specification conditions that specify the period for supplying information and information reception condition specification conditions that specify at least a value of said information reception conditions.

4. The information supply system according to claim 1, wherein said local server means further comprising:
subscriber terminal detecting means for detecting that said service subscriber terminal has moved to the own service area; and
channel controlling means for establishing a radio channel with said service subscriber terminal that has moved and informing said information selecting means of the establishment of the radio channel.

5. The information supply system according to claim 1,
wherein a push condition to specify whether auto distribution is available or not is specified for each piece of information stored in said information database means, and
said information supplying means automatically transmits the information for which said push condition specifies that auto distribution is available from among the information pieces selected by said information selecting means to said service subscriber terminal existing in said service area.

6. The information supply system according to claim 1, wherein said information supplying means further supplies broadcast data virtually consecutively supplied to said service subscriber terminal as said information.

7. The information supply system according to claim 1, wherein said information supplying means presents said information in response to information request from said service subscriber terminal existing in said service area.

8. The information supply system according to claim 1, wherein said central server means distributes the relevant reception information to necessary local server means based on said transmission destination specification condition of the information received from each of said local server means.

9. A control method of information supply system which includes at least one local server means having a service area with a predetermined range and a central server means to connect between said local server means, information database means for storing information with which transmission destination specification conditions are associated and subscriber database means for storing information reception conditions set for each of service subscriber terminals and which supplies pre-stored information to said service subscriber terminal existing in said service area, comprising:
an information selecting step of comparing said information reception condition corresponding to said service subscriber terminal existing in the service area of said local server means with said information transmission destination specification condition using said information database means and said subscriber database means and selecting only information having said transmission destination specification condition that satisfies said information reception condition; and
an information supplying step of presenting only the information selected by said information selecting step to said service subscriber terminal existing in said service area.

10. The information supply system control method according to claim 9, wherein both said information selecting step and said information supplying step are executed by said local server means.

11. The information supply system control method according to claim 9, wherein said transmission destination specification condition includes at least one of location specification conditions for specifying the local server means as the transmission destination, period specification conditions for specifying the period of supplying information and information reception condition specification conditions for specifying at least some values of said information reception conditions.

12. The information supply system control method according to claim 9, further comprising:
a subscriber terminal detecting step, performed at said local server means, of detecting that said service subscriber terminal has moved to its own service area; and
a channel control step, performed at said local server means, of establishing a radio channel with said service subscriber terminal that has moved and notifying the information to said information selecting step.

13. The information supply system control method according to claim 9,
wherein a push condition for specifying whether auto distribution is available or not is specified for each piece of information stored in said information database means, and
said information supplying step automatically transmits the information for which said push condition specifies that auto distribution is available from among the information pieces selected by said information selecting step to said service subscriber terminal existing in said service area.

14. The information supply system control method according to claim 9, wherein said information supplying step provides broadcast data virtually continuously supplied to said service subscriber terminal as said information.

15. The information supply system control method according to claim 9, wherein said information supply step presents said information in response to information request from said service subscriber terminal existing in said service area.

16. The information supply system control method according to claim 9, wherein said central server means has a step of distributing relevant reception information to the necessary local server means based on said transmission destination specification condition of the information received from each of said local server means.
